(19) United States
(12) Patent Application Publication
(10) Pub. No.: US 2007/0024197 A1
(43) Pub. Date: Feb. 1, 2007

(54) Plasma display panel device with fluorescent layer protector

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/397,018

(22) Filed: Apr. 3, 2006

(30) Foreign Application Priority Data
Jul. 27, 2005 (CN) 200510036250.1

(51) Int. Cl. H01J 17/49

(52) U.S. Cl. 313/587; 313/582; 313/586

(57) ABSTRACT

A plasma display panel device includes an upper substrate and a bottom substrate. A dielectric layer, a plurality of displaying electrodes and scanning electrodes are arranged on an inner surface of the upper substrate. A plurality of addressing electrodes and blue fluorescent layers are arranged on an inner surface of the bottom substrate. An optical film stack is formed on a surface of each blue fluorescent layer. The optical film stack includes a plurality of first optical units, and a plurality of second optical units located on the plurality of first optical units. Each of the first optical units and the second optical units respectively includes a high refractive index film and a low refractive index film.

### BACKGROUND OF THE INVENTION

1. Technical Field

The present invention relates to a flat panel display (FPD) device, and more particularly to a plasma display panel (PDP) device.

2. Description of the Prior Art

With the ongoing development of the FPD device, it is now being used in a variety of applications such as personal computers, mobile devices, consumer electrical products, and so on. FPD devices in widespread use include PDP devices, liquid crystal display (LCD) devices, and field emission display (FED) devices. Compared with LCD and FED devices, the PDP device in general has the characteristics of thinness, lightness (in weight), uniform brightness, fast response speed, large view angle, high resolution, no radiation of X-rays, etc. In addition, a PDP device with a so-called super large size (generally larger than 40 inches) is relatively easy to manufacture.

The PDP device uses gas discharge to obtain the display. A display panel of the PDP device uses plasma tubes as luminous elements. Many plasma tubes are arranged in an array to form the display panel. A suitable inert gas is sealed in each plasma tube. The inert gas is generally a mixture of helium and xenon, or a mixture of neon and xenon. When a voltage is applied to electrodes of the plasma tube, the inert gas discharges and generates ultraviolet (UV) rays having primary wavelengths lower than 200 nanometers. The UV rays of multiple plasma tubes irradiate a corresponding multiplicity of primary colored fluorescent layers, such as red fluorescent layers, green fluorescent layers, and blue fluorescent layers. Then the fluorescent layers generate corresponding visible red light, green light, and blue light. Each of the plasma tubes is used as a sub-pixel. The cooperation of on-off switching and corresponding color changes of all the sub-pixels enables the display panel to generate pictures with various gray levels and colors.

Compared with red light and green light, the wavelength of blue light is near the wavelength of UV radiation. UV rays can degenerate the blue fluorescent layers relatively easily In particular, under high temperature conditions, when the blue fluorescent layers are directly irradiated by UV rays, the blue fluorescent layers are liable to overheat and decay. Accordingly, the blue light generated by the blue fluorescent layers is degraded. For example, the intensity and purity of the blue light is diminished. Thus when the red light, the green light, and the degraded blue light mix, the display quality of the PDP device may be significantly reduced.

What is needed, therefore, is a plasma display panel device that can increase the efficiency and durability of blue fluorescent layers thereof.

### SUMMARY

A plasma display panel device is provided. The plasma display panel device includes an upper substrate and a bottom substrate. A dielectric layer, a plurality of displaying electrodes, and a plurality of scanning electrodes are arranged on an inner surface of the upper substrate. A plurality of addressing electrodes and blue fluorescent layers are arranged on an inner surface of the bottom substrate. An optical film stack is formed on the surface of each blue fluorescent layer. The optical film stack includes a plurality of first optical units, and a plurality of second optical units located on the plurality of first optical units. Each of the first optical units and second optical units respectively includes a high refractive index film and a low refractive index film. A first reference thickness of the high refractive index film is equal to λ/4n₁, and a second reference thickness of the low refractive index film is equal to λ/4n₂. In these equations, λ stands for a reference wavelength, n₁ stands for the index of the high refractive index film, and n₂ stands for the index of the low refractive index film.

Other advantages and novel features will become more apparent from the following detailed description of the present plasma display panel device when taken in conjunction with the accompanying drawings.

### BRIEF DESCRIPTION OF THE DRAWINGS

The components in the drawings are not necessarily to scale, the emphasis instead being placed upon clearly illustrating the principles of the present plasma display panel device. Moreover, in the drawings, like reference numerals designate corresponding parts throughout the several views.

FIG. 1 is an isometric, cut-away view showing part of a plasma display panel device in accordance with a preferred embodiment of the present invention.

FIG. 2 is an enlarged, schematic, abbreviated, side cross-sectional view of an optical film stack of the plasma display panel device of FIG. 1.

### DETAILED DESCRIPTION OF THE EMBODIMENTS

Reference will now be made to the drawing figures to describe preferred embodiments in detail.

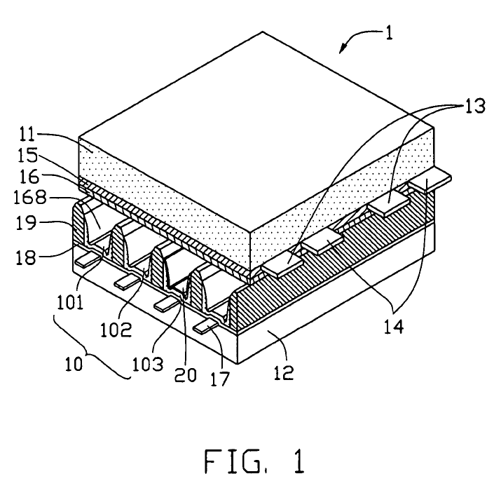

Referring to FIG. 1, a plasma display panel (PDP) device 1 in accordance with a preferred embodiment is shown. The PDP device 1 includes an upper substrate 11 and a bottom substrate 12. Both the upper substrate 11 and the bottom substrate 12 are made of transparent material, such as glass.

A plurality of parallel displaying electrodes 13 and scanning electrodes 14 are alternately arranged on an inner surface of the upper substrate 11. A transparent dielectric layer 15 covers the scanning electrodes 14 and the displaying electrodes 13, so that the scanning electrodes 14 and the displaying electrodes 13 are embedded in the transparent dielectric layer 15. A protection layer 16 covers the transparent dielectric layer 15. The displaying electrodes 13 and the scanning electrodes 14 can be generally made of chromium (Cr), copper (Cu), or silver (Ag). A material of the transparent dielectric layer 15 is generally indium tin oxide (ITO) or tin oxide (SnO₂). The protection layer 16 is generally made of magnesium oxide (MgO).

An inner surface of the bottom substrate 12 faces toward the inner surface of the upper substrate 11. A plurality of parallel addressing electrodes 17 is arranged on the inner surface of the bottom substrate 12. An insulating layer 18 covers the addressing electrodes 17, so that the addressing electrodes 17 are embedded in the insulating layer 18. A plurality of parallel barrier walls 19 extends up from the insulating layer 18. Each barrier wall 19 generally separates two adjacent addressing electrodes 17. A plurality of parallel fluorescent layer units 10 are coated on exposed regions of the insulating layer 18 and side surfaces of the barrier walls 19. Each fluorescent layer unit 10 includes three parallel primary color layers. In the preferred embodiment, the primary color layers are a red fluorescent layer 101, a green fluorescent layer 102, and a blue fluorescent layer 103. A material of the barrier walls 19 is generally silicon oxide (SiO₂). The protection layer 16, each two successive barrier walls 19, and a corresponding primary color layer cooperatively define a space 168 therebetween. A suitable inert gas is sealed inside the spaces 168. The inert gas can for example be a mixture of helium and xenon, or a mixture of neon and xenon.

When a voltage is applied between the displaying electrodes 13 and the scanning electrodes 14, the inert gas sealed inside the spaces 168 discharges and generates UV rays. The UV rays irradiate the red fluorescent layers 101, the green fluorescent layers 102, and the blue fluorescent layers 103, and visible red light, green light, and blue light is emitted from an outer surface of the upper substrate 11.

A material of each red fluorescent layer 101 includes Y₂O₃:Eu²⁺, YBO₃:Eu³⁺, or GdBO₃:Eu³⁺. A material of each green fluorescent layer 102 includes Zn₂SiO₄:Mn²⁺, ZnSiOₓ:Mn²⁺, or aluminate doped with Mn²⁺. A material of each blue fluorescent layer 103 includes BaMgAlOₓ₁:Eu²⁺, CaMgSiOₓ₂:Eu²⁺, BaMgAl₁₀O₁₇:Eu²⁺, or aluminate doped with Eu²⁺. A numerical value of x is one or two. A numerical value of x1 is one, two, or three. A numerical value of x2 is one or two.

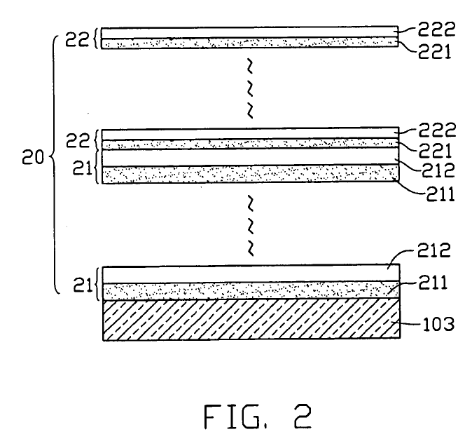

Referring to FIG. 2, an optical film stack 20 is formed on each blue fluorescent layer 103. The optical film stack 20 includes a plurality of double-layered first optical units 21, and a plurality of double-layered second optical units 22 stacked on the plurality of first optical units 21. In the preferred embodiment, there are seven first optical units 21, and six second optical units 22 stacked on the first optical units 21. The seven first optical units 21 are sandwiched between a bottommost one of the second optical units 22 and the blue fluorescent layer 103.

Each of the first optical units 21 includes a high refractive index film 211 and a low refractive index film 212. Each of the second optical units 22 includes a high refractive index film 221 and a low refractive index film 222. Therefore, the optical film stack 20 has a total of twenty-six films.

A reference thickness of each high refractive index film 211 is represented by a reference character H, and a reference thickness of each low refractive index film 212 is represented by a reference character L. The value of H is equal to λ/4n₁, and the value of L is equal to λ/4n₂, wherein k is a reference wavelength (see below), n₁ is a refractive index of the high refractive index film 211, and n₂ is a refractive index of the low refractive index film 212.

A physical thickness of each high refractive index film 211 is H multiplied by a first coefficient. A physical thickness of each low refractive index film 212 is L multiplied by a second coefficient. Both the first coefficient and the second coefficient are 1.

A reference thickness of each high refractive index film 221 is also represented by the reference character H, and a reference thickness of each low refractive index film 222 is also represented by the reference character L. A physical thickness of each high refractive index film 221 is H multiplied by a third coefficient. A physical thickness of each low refractive index film 222 is L multiplied by a fourth coefficient. Both the third coefficient and the coefficient are 0.76.

A material of the high refractive index films 211 and 221 can be titanium oxide (TiO₂), in which case n₁ is equal to 2.705. A material of the low refractive index films 212 and 222 can be silicon oxide (SiO₂), in which case n₂ is equal to 1.499. When λ is determined, the numerical values of H and L are also determined. The value of λ is typically selected from a value in the range from 200 to 380 nanometers. A physical thickness of each of layers (i.e., films) of the optical film stack 20 is shown in table 1. The layers are numbered in order from bottom to top.

TABLE 1

| Number of layer | Physical thickness |
|---|---|
| 1 | H |
| 2 | L |
| 3 | H |
| 4 | L |
| 5 | H |
| 6 | L |
| 7 | H |
| 8 | L |
| 9 | H |
| 10 | L |
| 11 | H |
| 12 | L |
| 13 | H |
| 14 | L |
| 15 | 0.76H |
| 16 | 0.76L |
| 17 | 0.76H |
| 18 | 0.76L |
| 19 | 0.76H |
| 20 | 0.76L |
| 21 | 0.76H |
| 22 | 0.76L |
| 23 | 0.76H |
| 24 | 0.76L |
| 25 | 0.76H |
| 26 | 0.76L |

In general, it is desired that the optical film stack 20 can prevent UV rays in the wavelength band from 200 to 380 nanometers from transmitting therethrough, while still allowing UV rays with wavelengths less than 200 nanometers to transmit therethrough. This is because UV rays in the wavelength band from 200 to 380 nanometers are most likely to be harmful to the corresponding blue fluorescent layer 103, whereas UV rays with wavelengths less than 200 nanometers can provide the needed excitation of the blue fluorescent layer 103. For example, UV radiation with a primary wavelength of approximately 147 nanometers is understood to provide excitation of material in a blue fluorescent layer such as the blue fluorescent layer 103. Under a condition that the optical film stack 20 can cut the transmittance of UV rays to less than five percent for wavelengths in the range from 200 to 380 nanometers and let larger than ninety percent of visible light for wavelengths in the range from 400 to 650 nanometers to pass therethrough, a suitably programmed computer can optimize characteristics of the optical film stack 20. A structure of an exemplary optimized optical film stack 20 is shown in table 2. In the exemplary optimization process, the value of λ is selected to be 320 nanometers, the material of the high refractive index films 212 and the high refractive index films 222 is selected to be TiO₂, and the material of the low refractive index films 211 and the low refractive index films 212 is selected to be SiO₂. Accordingly, n₁ is equal to 2.705, n₂ is equal to 1.499, the value of H is equal to 320/(4×2.705), and the value of L is equal to 320/(4×1.499). Thus, the physical thickness calculated for each layer of the optical film stack 20 is as shown in table 2.

TABLE 2

| Number of layer | Physical thickness |
|---|---|
| 1 | 0.372H |
| 2 | 1.203L |
| 3 | 0.849H |
| 4 | 0.962L |
| 5 | 1.064H |
| 6 | 0.967L |
| 7 | 1.048H |
| 8 | 1.011L |
| 9 | 1.045H |
| 10 | 0.988L |
| 11 | 1.061H |
| 12 | 0.960L |
| 13 | 1.017H |
| 14 | 0.973L |
| 15 | 0.698H |
| 16 | 0.764L |
| 17 | 0.477H |
| 18 | 0.818L |
| 19 | 0.787H |
| 20 | 0.679L |
| 21 | 0.822H |
| 22 | 0.389L |
| 23 | 0.946H |
| 24 | 0.655L |
| 25 | 0.764H |
| 26 | 2.183L |

From table 2 above, it can be seen that the first coefficients of the high refractive index films 211 are in the range from 0.372 to 1.064, the second coefficients of the low refractive index films 212 are in the range from 0.962 to 1.203, the third coefficients of the high refractive index films 221 are in the range from 0.477 to 0.946, and the fourth coefficients of the low refractive index films 222 are in the range from 0.389 to 2.183.

To summarize the exemplary optimized optical film stack 20, when the physical thicknesses of the films 211, 212, 221, 222 are as shown in table 2, the optical film stack 20 can cut the transmittance of UV rays to less than five percent for wavelengths in the range from 200 to 380 nanometers, and allow more than ninety percent of visible light for wavelengths in the range from 400 to 650 nanometers to pass therethrough.

In alternative embodiments, the optical film stack 20 can be located not only on each blue fluorescent layer 103, but also on either or both of each red fluorescent layer 101 and each green fluorescent layer 102.

In summary of the preferred embodiment, the blue fluorescent layers 103 of the PDP device 1 are coated with plural high and low refractive index films 211, 212, 221, 222. The films 211, 212, 221, 222 prevent the blue fluorescent layers 103 from being directly exposed to harmful UV rays. Therefore the harmful UV rays are substantially or even completely prevented from inducing overheating and decay of the blue fluorescent layers 103.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A plasma display panel device, comprising:
an upper substrate formed with a dielectric layer, a plurality of displaying electrodes, and a plurality of scanning electrodes; and
a bottom substrate formed with a plurality of addressing electrodes, and a plurality of blue fluorescent layers above the addressing electrodes;
wherein, an optical film stack is formed on each of the blue fluorescent layers, the optical film stack has a plurality of first optical units, and a plurality of second optical units located on the plurality of first optical units; and
each of the first optical units and the second optical units has a high refractive index film and a low refractive index film, a first reference thickness of the high refractive index film is equal to λ/4n₁, a second reference thickness of the low refractive index film is equal to λ/4n₂, λ is a reference wavelength, n₁ is a refractive index of the high refractive index film, and n₂ is a refractive index of the low refractive index film.

2. The plasma display panel device as recited in claim 1, wherein a physical thickness of the high refractive index film of the first optical unit is equal to the first reference thickness multiplied by a first coefficient, a physical thickness of the low refractive index film of the first optical unit is equal to the second reference thickness multiplied by a second coefficient, a physical thickness of the high refractive index film of the second optical unit is equal to the first reference thickness multiplied by a third coefficient, a physical thickness of the low refractive index film of the second optical unit is equal to the second reference thickness multiplied by a fourth coefficient, and ranges of the first, the second, the third, and the fourth coefficients are respectively from 0.372 to 1.064, 0.960 to 1.203, 0.477 to 0.946, and 0.389 to 2.183.

3. The plasma display panel device as recited in claim 2, wherein the first, the second, the third, and the fourth coefficients are respectively 1, 1, 0.76, and 0.76.

4. The plasma display panel device as recited in claim 3, wherein the value of the reference wavelength is between 200 and 380 nanometers.

5. The plasma display panel device as recited in claim 4, wherein the value of the reference wavelength is 320 nanometers.

6. The plasma display panel device as recited in claim 1, wherein the high refractive index films of both the first optical units and the second optical units are made of titanium oxide.

7. The plasma display panel device as recited in claim 6, wherein the refractive index n₁ of the high refractive index films is 2.705.

8. The plasma display panel device as recited in claim 6, wherein the low refractive index films of both the first optical units and the second optical units are made of silicon oxide.

9. The plasma display panel device as recited in claim 8, wherein the refractive index n₂ of the low refractive index films is 1.499.

10. The plasma display panel device as recited in claim 1, wherein the number of first optical units is seven.

11. The plasma display panel device as recited in claim 10, wherein the number of second optical units is six.

12. The plasma display panel device as recited in claim 1, wherein the blue fluorescent layers comprise BaMgAlOₓ₁:Eu²⁺, CaMgSiOₓ₂:Eu²⁺, BaMgAl₁₀O₁₇:Eu²⁺, or aluminate doped with Eu²⁺, a numerical value of x1 being one, two, or three, and a numerical value of x2 being one or two.

13. The plasma display panel device as recited in claim 1, wherein the red fluorescent layers comprise Y₂O₃:Eu²⁺, YBO₃:Eu³⁺, or GdBO₃:Eu³⁺.

14. The plasma display panel device as recited in claim 1, wherein the green fluorescent layers comprise Zn₂SiO₄:Mn²⁺, ZnSiOₓ:Mn²⁺, or aluminate doped with Mn²⁺, a numerical value of x being one or two.

15. The plasma display panel device as recited in claim 1, further comprising a plurality of red fluorescent layers and green fluorescent layers above the addressing electrodes.

16. The plasma display panel device as recited in claim 15, wherein an optical unit is also formed on each of the red fluorescent layers and the green fluorescent layers, and the optical unit has a same structure as the optical unit formed on each of the blue fluorescent layers.
